(19) United States
(12) Patent Application Publication
(10) Pub. No.: US 2012/0155351 A1
(43) Pub. Date: Jun. 21, 2012

(54) APPARATUS AND METHOD FOR DELIVERY OF DISCARDED PACKET IN BROADBAND WIRELESS ACCESS SYSTEM

(75) Inventors: Ji-Cheol LEE, Suwon-si (KR); Jung-Shin PARK, Seoul (KR); Hyun-Jeong KANG, Seoul (KR)

(73) Assignee: Samsung Electronics Co., Ltd., Suwon-si (KR)

(21) Appl. No.: 13/312,182

(22) Filed: Dec. 6, 2011

(30) Foreign Application Priority Data
Dec. 17, 2010 (KR) 10-2010-0129614

(51) Int. Cl. H04W 52/02

(52) U.S. Cl. 370/311

(57) ABSTRACT

An operation method of a terminal in a wireless access system is provided. The method includes, while keeping an idle state without confirming the existence or non-existence of downlink data, determining to transit into a wakeup state, performing signaling for the transition into the wakeup state, acquiring information on discarded downlink data transmission through the signaling, and receiving the downlink data using the information on the downlink data transmission.

### PRIORITY

This application claims the benefit under 35 U.S.C. §119(a) of a Korean patent application filed in the Korean Intellectual Property Office on Dec. 17, 2010 and assigned Serial No. 10-2010-0129614, the entire disclosure of which is hereby incorporated by reference.

### BACKGROUND OF THE INVENTION

1. Field of the Invention

The present invention relates to a broadband wireless access system More particularly, the present invention relates to an apparatus and method for later again delivering a packet discarded due to a reception disabled state of a terminal in a broadband wireless access system.

2. Description of the Related Art

In the 4^{th} Generation (4G) communication system, which is the generation communication system, intensive research is being conducted to provide users with services of various Qualities of Service (QoS) at a data rate of about 100 Mega Bits Per Second (Mbps). More particularly, a study of the 4G communication system is now made to support high-speed services in the way of guaranteeing mobility and QoS for a Broadband Wireless Access (BWA) communication system such as a Wireless Local Area Network (WLAN) system and a Wireless Metropolitan Area Network (WMAN) system. Also, the typical 4G communication system is an Institute of Electrical and Electronics Engineers (IEEE) 802.16 communication system.

An IEEE 802.16m system, which is one of the IEEE 802.16 system standards, defines a Deregistration with Content Retention (DCR) mode. The DCR mode is an operation state in which a terminal deregisters a network, receives no downlink signal, and re-enters the network when uplink data to be transmitted is generated. If the uplink data of the terminal is generated, the terminal temporarily restores connection, and again enters a communication disabled state. Accordingly, the DCR mode is an operation state very suitable to a terminal of a format in which transmission data is generated at a user side only.

However, although communication is of a format in which transmission data is generated mainly at a user side only, it is difficult that no downlink data is generated in real communication circumstances. For example, reception of downlink data such as emergency, information essentially necessary for communication, information essentially necessary for exhibiting a function of a terminal and the like can be required. But, although the downlink data to be transmitted to the terminal operating in the DCR mode is generated, a Base Station (BS) cannot deliver the downlink data to the terminal as far as the terminal is not out of the DCR mode.

Accordingly, there is a need to propose an alternative for delivering downlink data generated while a terminal operating in a DCR mode does not perform communication, to the terminal.

### SUMMARY OF THE INVENTION

Aspects of the present invention are to address at least the above-mentioned problems and/or disadvantages and to provide at least the advantages described below. Accordingly, an aspect of the present invention is to provide an apparatus and method for delivering downlink data to a terminal that keeps an idle state without confirming the existence or non-existence of the downlink data in a broadband wireless access system.

Another aspect of the present invention is to provide an apparatus and method for, when a terminal keeping an idle state without confirming the existence or non-existence of the downlink data wakes up, informing the existence of discarded downlink data in a broadband wireless access system.

A further aspect of the present invention is to provide an apparatus and method for, when a terminal keeping an idle state without confirming the existence or non-existence of downlink data wakes up, forcing a wakeup state for the sake of downlink data transmission in a broadband wireless access system.

In accordance with an aspect of the present invention, an operation method of a terminal in a broadband wireless access system is provided. The method includes, while keeping an idle state without confirming the existence or non-existence of downlink data, determining to transit into a wakeup state, performing signaling for the transition into the wakeup state, acquiring information on discarded downlink data transmission through the signaling, and receiving the downlink data using the information on the discarded downlink data transmission.

In accordance with another aspect of the present invention, an operation method of a control station in a broadband wireless access system is provided. The method includes, if downlink data for a terminal being in an operation mode of keeping an idle state without confirming the existence or non-existence of downlink data is generated, discarding or buffering the downlink data, storing information about the downlink data, if there is a request for a state change into a wakeup state of the terminal, transmitting information on discarded downlink data transmission through a signaling procedure for the state change, reacquiring discarded downlink data, and transmitting the discarded downlink data.

In accordance with a further aspect of the present invention, an operation method of a Base Station (BS) in a broadband wireless access system is provided. The method includes, if a first message of requesting for transition into a wakeup state is received from a terminal being in an operation mode of keeping an idle state without confirming the existence or non-existence of downlink data, transmitting a control station a second message of requesting for a state change of the terminal and, if a response message including information on transmission of discarded downlink data to be transmitted to the terminal is received in response to the second message, transmitting the terminal a response message including the information on a discarded downlink data transmission in response to the first message.

In accordance with a yet another aspect of the present invention, a terminal apparatus in a broadband wireless access system is provided. The apparatus includes a controller and a modulator/demodulator (modem). While keeping an idle state without confirming the existence or non-existence of downlink data, the controller determines to transit into a wakeup state, performs signaling for the transition into the wakeup state, and acquires information on discarded downlink data transmission through the signaling. The modem receives the downlink data using the information on the discarded downlink data transmission.

In accordance with a still another aspect of the present invention, a control station apparatus in a broadband wireless access system is provided. The apparatus includes a controller and a communication unit. If downlink data for a terminal being in an operation mode of keeping an idle state without confirming the existence or non-existence of downlink data is generated, the controller discards or buffers the downlink data, and stores information about the downlink data. If there is a request for a state change into a wakeup state of the terminal, the communication unit transmits information on discarded downlink data transmission through a signaling procedure for the state change. The controller controls to reacquire the discarded downlink data, and transmit the discarded downlink data.

In accordance with a still another aspect of the present invention, a BS apparatus in a broadband wireless access system is provided. The apparatus includes a modem and a controller. If a first message of requesting for transition into a wakeup state is received from a terminal being in an operation mode of keeping an idle state without confirming the existence or non-existence of downlink data, the modem transmits a control station a second message of requesting for a state change of the terminal. If a response message including information on transmission of discarded downlink data to be transmitted to the terminal is received in response to the second message, the controller controls to transmit the terminal a response message including the information on the discarded downlink data transmission in response to the first message.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will become more apparent from the following description taken in conjunction with the accompanying drawings, in which:

FIG. 1 is a diagram illustrating a schematic construction of a broadband wireless access system according to an exemplary embodiment of the present invention;

FIG. 2 is a ladder diagram illustrating a signal exchange for discarded packet delivery in a broadband wireless access system according to an exemplary embodiment of the present invention;

FIG. 3 is a flowchart illustrating an operation procedure of a terminal in a broadband wireless access system according to an exemplary embodiment of the present invention;

FIG. 4 is a flowchart illustrating an operation procedure of a Base Station (BS) in a broadband wireless access system according to an exemplary embodiment of the present invention;

FIG. 5 is a flowchart illustrating an operation procedure of a control station in a broadband wireless access system according to an exemplary embodiment of the present invention;

FIG. 6 is a block diagram illustrating a construction of a terminal in a broadband wireless access system according to an exemplary embodiment of the present invention;

FIG. 7 is a block diagram illustrating a construction of a BS in a broadband wireless access system according to an exemplary embodiment of the present invention; and

FIG. 8 is a block diagram illustrating a construction of a control station in a broadband wireless access system according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention is provided for purposes of illustration only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A technology for delivering downlink data to a terminal keeping an idle state without confirming the existence or non-existence of the downlink data in a broadband wireless access system is described below.

The following description is, for example, made for a Deregistration with Content Retention (DCR) mode defined in an Institute of Electrical and Electronics Engineers (IEEE) 802.16m system as a state in which a terminal keeps an idle state without confirming the existence or non-existence of downlink data. However, the present invention is not limited to the DCR mode, and is identically applicable if it is a terminal keeping an idle state without confirming the existence or non-existence of downlink data.

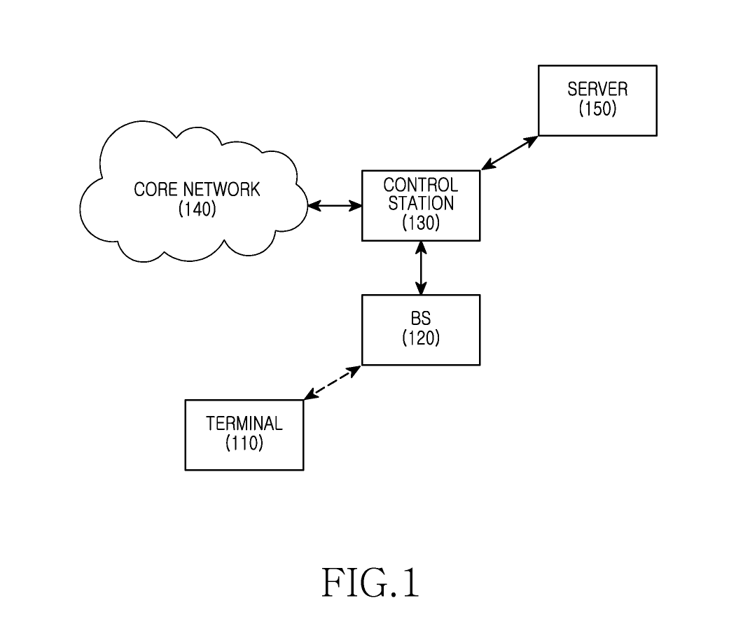

FIG. 1 illustrates a schematic construction of a broadband wireless access system according to an exemplary embodiment of the present invention.

Referring to FIG. 1, the broadband wireless access system includes a terminal 110, a Base Station (BS) 120, a control station 130, a core network 140, and a server 150.

The terminal 110 is an end equipment receiving a service through a wireless access network. The terminal 110 can be either a mobile equipment carried by a user or a machine device performing only a preset function without the user's intervention. The terminal 110 can operate in an operation mode, for example, a DCR mode of keeping an idle state without confirming the existence or non-existence of downlink data and temporarily returning to a wakeup state only at uplink data generation.

The BS 120 is a device for performing communication through a wireless channel with the terminal 110, and providing wireless access to the terminal 110. The BS 120 manages a wireless resource, and allocates the wireless resource to the terminal 110. The control station 130 performs a role of a gateway between the core network 140 and the wireless access network. If downlink data for the terminal 110 is generated in the core network 140 or the server 150, the control station 130 delivers the downlink data to the terminal 110, and delivers uplink data of the terminal 110 to the core network 140 or the server 150. According to the kind of a system, the control station 130 can be denoted as an Access Service Network-Gateway (ASN-GW), a Paging Controller (PC), a Mobility Management Entity (MME), an authenticator and the like.

The core network 140 is a communication network intending to be connected through the wireless access network and can be, for example, an Internet network. The server 150 is an entity for realizing a specific function within the wireless access network and can be, for example, a Short Message Service (SMS) server providing a short message service and a Machine to Machine (M2M) server managing M2M terminals.

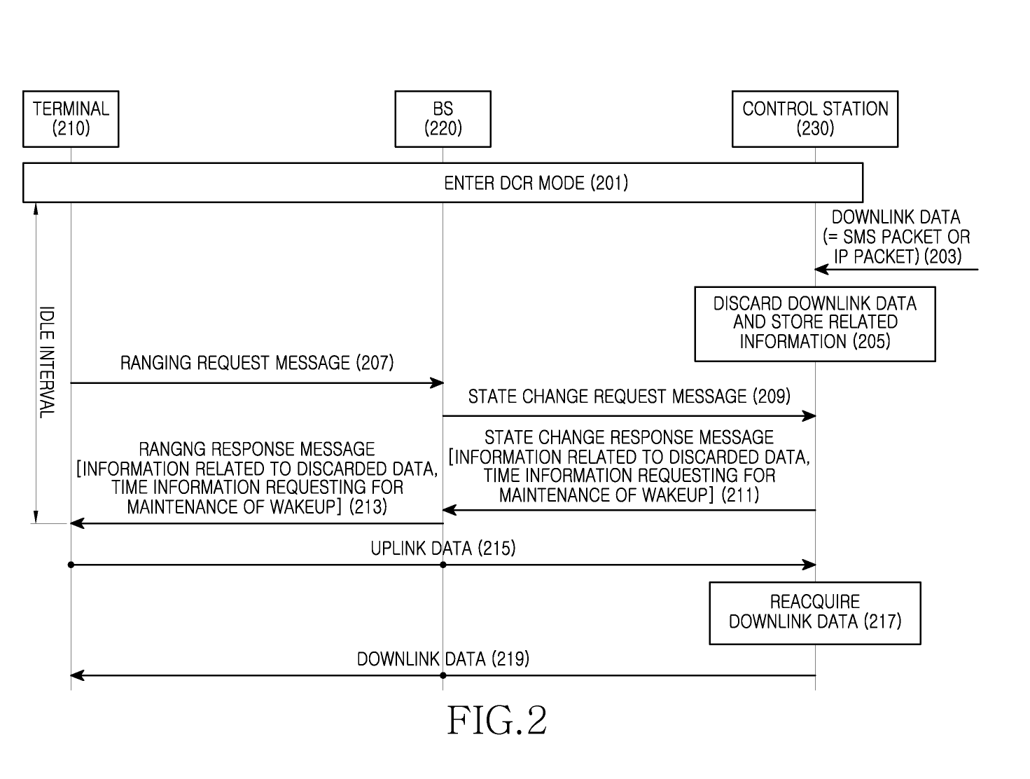

FIG. 2 illustrates a signal exchange for discarded packet delivery in a broadband wireless access system according to an exemplary embodiment of the present invention.

Referring to FIG. 2, in step 201, a terminal 210 enters a DCR mode. For the sake of DCR mode entry of the terminal 210, the terminal 210 can perform signaling with a BS 220 and a control station 230. Accordingly, the control station 230 recognizes that the terminal 210 operates in the DCR mode.

In step 203, the control station 230 receives downlink data for the terminal 210 from an intranet server or core network. For example, the downlink data can be an Internet Protocol (IP) packet, an SMS packet, an M2M data and the like.

In step 205, as the control station 230 recognizes that the terminal 210 is operating in the DCR mode, the control station 230 determines that it cannot transmit the downlink data. That is, as the terminal 210 operating in the DCR mode does not confirm paging or non-paging, the terminal 210 cannot perform communication before waking up itself Accordingly, the control station 230 discards the downlink data, and stores related information of the downlink data. For example, the related information can include the number of packets included in the discarded downlink data, the kind of packets included in the discarded downlink data, a size per all or packet of the discarded downlink data, a resource amount or time necessary for transmitting the discarded downlink data, information on a sender of the discarded downlink data, timing of generation of the discarded downlink data, and the like. At this time, according to another exemplary embodiment of the present invention, the control station 230 can buffer, without discarding, the downlink data.

In step 207, the terminal 210 keeping the idle state determines to convert into a wakeup state, and transmits to the BS 220 a ranging request message of requesting for transition into the wakeup state. For example, in a case where uplink data to be transmitted is generated or a predefined time point of reception of downlink data arrives, the terminal 210 determines to convert into the wakeup state.

Accordingly, in response to the received ranging request message, in step 209, the BS 210 transmits to the control station 230 a state change request message of requesting the wakeup of the terminal 210. The state change request message includes a request for wakeup and a request for provision of a context of the terminal 210, and can be denoted as an ‘IM_Exit_StateChange_Req’ message.

In step 211, in response to the received state change request message, the control station 230 transmits to the BS 220 a state change response message of accepting a state change. The state change response message can be denoted as an ‘IM_Exit_StateChange_Rsp’ message. The state change response message includes information on transmission of the downlink data discarded in step 205. The information on the downlink data transmission can include information representing the existence or non-existence of the discarded downlink data and information related to the discarded downlink data. Also, the information on the downlink data transmission can further include time information requesting for the maintenance of the wakeup state. Here, the information related to the discarded downlink data includes the related information stored in step 205. Also, the time information requesting for the maintenance of the wakeup state means a time necessary for transmitting all of the discarded downlink data, and can be decided with reference to a size of the downlink data. As an example, the information on the discarded downlink data transmission can include at least one of Information Elements (IEs) of Table 1 below.

TABLE 1

| | IE | Size | Description |
|---|---|---|---|
| LP_IE | Loss Packet | 1 bit | Indicate if there are |
| (Loss | Indicator | | packets discarded during |
| Packet IE) | (LPI) | | DCR mode |
| | Loss Packet Number | 2 bytes | Number of packets |
| | | | discarded during |
| | | | DCR mode |
| | Loss Packet Octet | 4 bytes | Octet count of packets |
| | Count | | discarded during |
| | | | DCR mode |
| SP_IE | SMS Loss Packet | 1 bit | Indicate if there are SMS |
| (SMS Loss | Indicator | | packets discarded during |
| Packet IE) | | | DCR mode |
| | Urgent SMS Loss | 1 bit | Indicate if there are urgent |
| | Packet | | SMS packets discarded |
| | | | during DCR mode |
| | SMS Loss Packet | 2 bytes | Number of SMS packets |
| | Number | | discarded during DCR |
| | | | mode |
| | SMS Loss Packet | 4 bytes | Octet count of SMS |
| | Octet Count | | packets discarded during |
| | | | DCR mode |
| DIR_IE | Wakeup Time | In | Terminal does not return |
| | | seconds | to DCR mode or idle |
| | | | mode during wakeup |
| | | | time |
| Additional | List of source IP | | |
| Information | addresses of the | | |
| | discarded message | | |
| | List of source | | |
| | addresses of the | | |
| | discarded SMS | | |
| | message or the | | |
| | discarded urgent | | |
| | SMS messages | | |

In step 213, in response to the received state change response message, the BS 220 transmits to the terminal 210 a ranging response message of accepting wakeup. Here, the ranging response message includes the information on the discarded downlink data transmission received through the state change response message.

In step 215, in response to the received ranging response message, the terminal 210 transmits uplink data. The uplink data is transmitted to the control station 230 via the BS 220. However, step 215 can be omitted in a case where the terminal 210 converts into a wakeup state due to the arrival of a predefined time point of reception of downlink data.

In step 217, the control station 230 reacquires the downlink data discarded in step 205. For instance, the control station 230 can transmit a request for retransmission to a sender of the downlink data. Or, in a case where the control station 230 has buffered the downlink data in step 205, the control station 230 can reacquire the downlink data by reading out the downlink data stored in a buffer. In step 219, the control station 230 transmits the downlink data to the terminal 210. The downlink data is transmitted to the terminal 210 via the BS 220.

In FIG. 2, it is illustrated that steps 217 and 219 are performed after transmission of the downlink data. However, this is one example, and step 217 can be carried out anytime after step 209. Also, step 219 can be carried out anytime after steps 213 and 217.

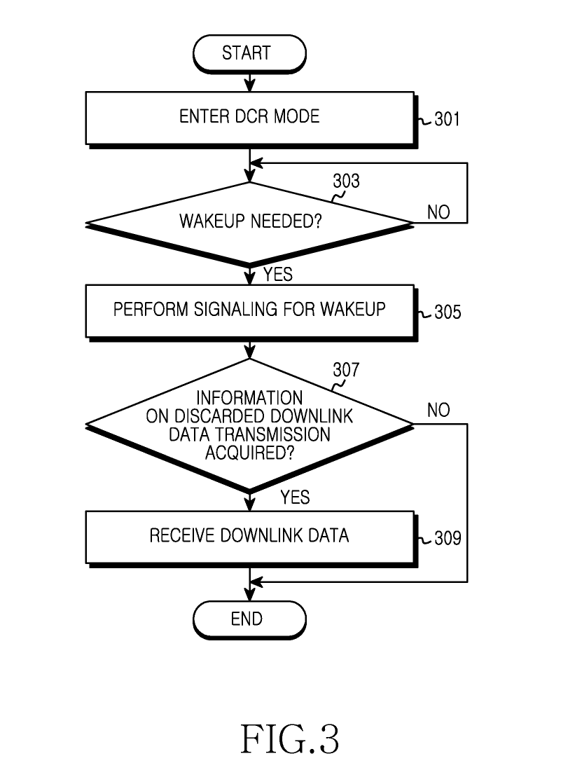

FIG. 3 illustrates an operation procedure of a terminal in a broadband wireless access system according to an exemplary embodiment of the present invention.

Referring to FIG. 3, in step 301, the terminal enters a DCR mode. For the sake of DCR mode entry, the terminal performs signaling with a BS and a control station. Accordingly, the control station recognizes that the terminal operates in the DCR mode. As entering the DCR mode, the terminal keeps an idle state without confirming the existence or non-existence of downlink data, i.e., confirming paging, as far as not converting into a wakeup state according to its own determination.

After entering the DCR mode, the terminal proceeds to step 303 and determines if there is a need to convert into the wakeup state. A cause of the transition into the wakeup state can be differently defined according to a characteristic of a system and an exemplary embodiment. For example, in a case where uplink data to be transmitted is generated or a predefined time point of reception of downlink data arrives, the terminal can determine to convert into the wakeup state.

In a case where the terminal determines the transition into the wakeup state, the terminal proceeds to step 305 and performs signaling for the transition into the wakeup state. That is, the terminal transmits a BS a message of requesting for the transition into the wakeup state, and receives a response message of accepting the transition into the wakeup state from the BS. For example, the message can be a ranging request/response message.

The terminal proceeds to step 307 and determines if information on discarded downlink data transmission has been acquired. In other words, the terminal determines if the information on the discarded downlink data transmission is included in the response message. For example, the information on the downlink data transmission can include information representing the existence or non-existence of the discarded downlink data, information on the discarded downlink data, and time information requesting for the maintenance of the wakeup state. Also, the information on the downlink data can include the number of packets included in the discarded downlink data, the kind of packets included in the discarded downlink data, a size per all or packet of the discarded downlink data, a resource amount or time necessary for transmitting the discarded downlink data, information on a sender of the discarded downlink data, timing of generation of the discarded downlink data and the like. As an example, the information on the discarded downlink data transmission can include at least one of IEs of Table 1 above.

If it is determined in step 307 that the information on the discarded downlink data transmission has been acquired, the terminal proceeds to step 309 and receives downlink data using the information on the discarded downlink data transmission. For example, in a case where the time information requesting for the maintenance of the wakeup state is included, the terminal does not return to an idle state during a requested time and waits reception of the downlink data. For another example, in a case where the information on the sender of the downlink data is included, the terminal can transmit a request for data retransmission to the sender.

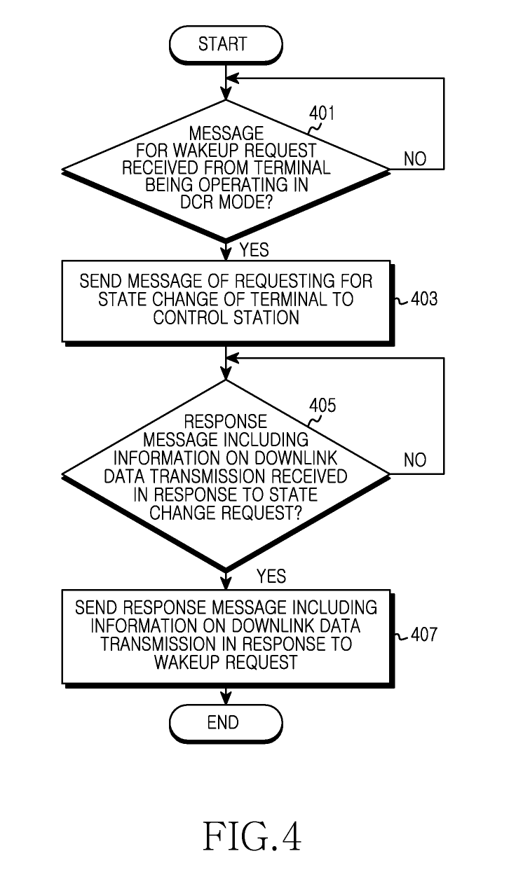

FIG. 4 illustrates an operation procedure of a BS in a broadband wireless access system according to an exemplary embodiment of the present invention.

Referring to FIG. 4, in step 401, the BS identifies if a message of requesting for transition into a wakeup state is received from a terminal operating in a DCR mode. For example, the message can be a ranging request message.

If it is identified in step 401 that the message of requesting for the transition into the wakeup state is received, the BS proceeds to step 403 and transmits a control station a message of requesting a state change of the terminal. The message of requesting the state change includes a request for wakeup and a request for provision of a context of the terminal, and can be denoted as an ‘IM_Exit_StateChange_Req’ message.

After that, the BS proceeds to step 405 and identifies if a state change response message including information on transmission of discarded downlink data is received from the control station in response to the state change request. The information on the downlink data transmission can include information representing the existence or non-existence of the discarded downlink data and information related to the discarded downlink data. Also, the information on the downlink data transmission can further include time information requesting for the maintenance of the wakeup state. Also, the time information requesting for the maintenance of the wakeup state means a time necessary for transmitting all of the discarded downlink data, and can be decided with reference to a size of the downlink data. As an example, the information on the discarded downlink data transmission can include at least one of IEs of Table 1 above.

If it is identified in step 405 that the response message including the information on the discarded downlink data transmission is received, the BS proceeds to step 407 and, in response to the wakeup request, transmits to the terminal a response message including the information on the discarded downlink data transmission.

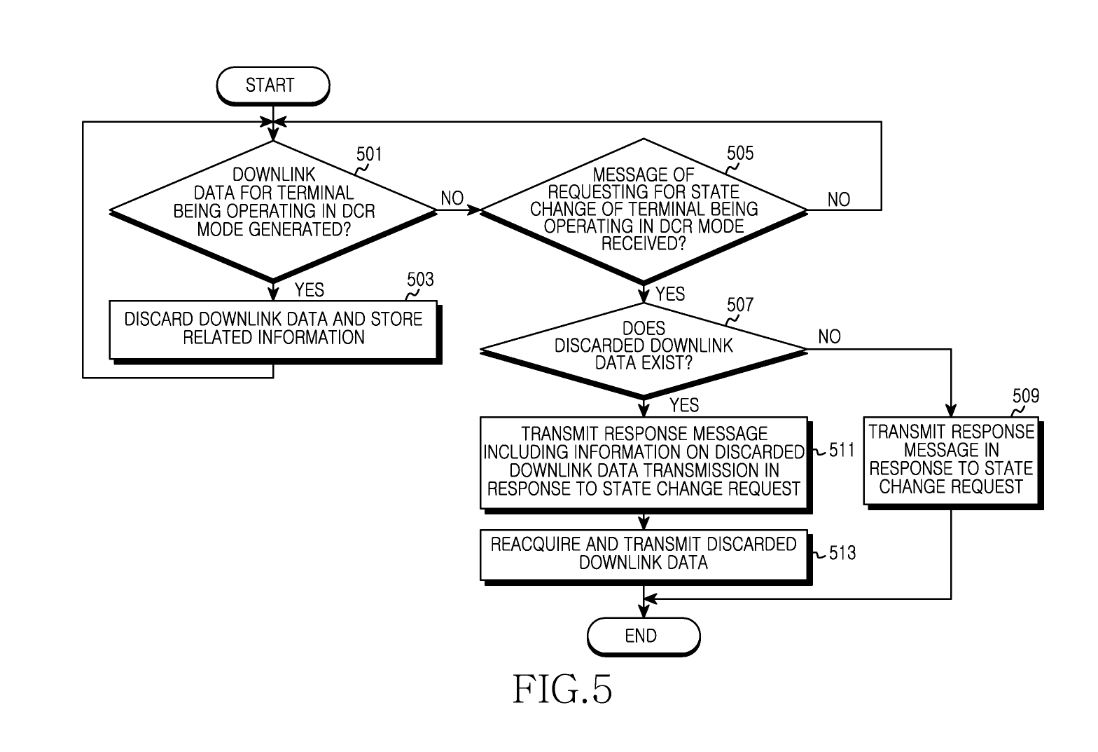

FIG. 5 illustrates an operation procedure of a control station in a broadband wireless access system according to an exemplary embodiment of the present invention.

Referring to FIG. 5, in step 501, the control station determines if downlink data for a terminal operating in a DCR mode is generated. That is, the control station identifies if the downlink data for the terminal is received from an intranet server or core network. For example, the downlink data can be an IP packet, an SMS packet, M2M data and the like.

If it is identified in step 501 that the downlink data for the terminal is generated, the control station proceeds to step 503 and discards the downlink data, and stores related information of the downlink data. That is, the control station determines that it cannot transmit the downlink data as the terminal is operating in the DCR mode, and discards the downlink data. For example, the related information can include the number of packets included in the discarded downlink data, the kind of packets included in the discarded downlink data, a size per all or packet of the discarded downlink data, a resource amount or time necessary for transmitting the discarded downlink data, information on a sender of the discarded downlink data, timing of generation of the downlink data and the like. However, according to another exemplary embodiment of the present invention, the control station can buffer, without discarding, the downlink data. After that, the control station returns to step 501.

If it is identified in step 501 that the downlink data is not generated, the control station proceeds to step 505 and determines if a message of requesting for a state change of the terminal operating in the DCR mode, that is, a message for requesting for transition into a wakeup state is received. The message of requesting the state change includes a request for wakeup and a request for provision of a context of the terminal, and can be denoted as an ‘IM_Exit_StateChange_Req’ message.

If it is determined in step 505 that the message of requesting for the state change is received, the control station proceeds to step 507 and determines if the downlink data to be transmitted to the terminal has been ever discarded due to the DCR mode, that is, if the discarded downlink data exists. At the time of downlink data discarding due to the DCR mode, the control station stores related information as in step 503, so the control station can determine the existence or non-existence of the discarded downlink data.

If it is determined in step 507 that the discarded downlink data to be transmitted to the terminal does not exist, the control station proceeds to step 509 and, in response to the state change request, transmits a response message. The response message can include information of a context of the terminal and information representing the acceptance or non-acceptance of a state change. After that, the control station terminates the procedure according to the present invention.

In contrast, in a case where it is determined in step 507 that the discarded downlink data to be transmitted to the terminal exists, the control station proceeds to step 511 and, in response to the state change request, transmits a response message including information related to transmission of the discarded downlink data. The information on the downlink data transmission can include information representing the existence or non-existence of the discarded downlink data and information related to the discarded downlink data. Also, the information on the downlink data transmission can further include time information requesting for the maintenance of the wakeup state. Here, the information related to the discarded downlink data includes related information stored in step 503. Also, the time information requesting for the maintenance of the wakeup state means a time necessary for transmitting all of the discarded downlink data, and can be decided with reference to a size of the downlink data. As an example, the information on the discarded downlink data transmission can include at least one of IEs of Table 1 above.

After that, the control station proceeds to step 513 and reacquires the discarded downlink data, and transmits the discarded downlink data. For example, the control station can transmit a request for retransmission to a sender of the downlink data. Or, in a case where the downlink data is buffered in step 503, the control station can reacquire the downlink data by reading the downlink data stored in a buffer.

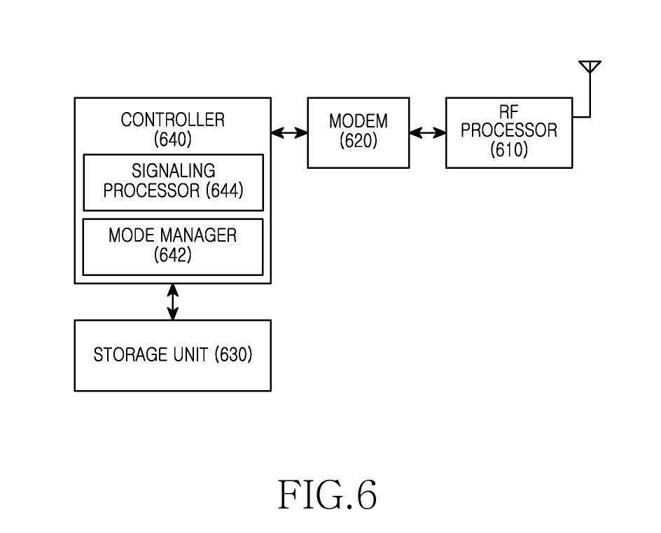

FIG. 6 illustrates a construction of a terminal in a broadband wireless access system according to an exemplary embodiment of the present invention.

Referring to FIG. 6, the terminal includes a Radio Frequency (RF) processor 610, a modulator/demodulator (modem) 620, a storage unit 630, and a controller 640.

The RF processor 610 performs a function for transmitting/receiving a signal through a wireless channel such as signal band transition, amplification and the like. That is, the RF processor 610 up-converts a baseband signal provided from the modem 620 into an RF band signal and transmits the RF band signal through an antenna, and down-converts an RF band signal received through the antenna into a baseband signal. For example, the RF processor 610 can include an amplifier, a mixer, an oscillator, a Digital to Analog Converter (DAC), an Analog to Digital Converter (ADC) and the like.

The modem 620 performs a function of transition between a baseband signal and a bit stream according to a physical layer standard of a system. For example, according to an Orthogonal Frequency Division Multiplexing (OFDM) scheme, at data transmission, the modem 620 generates complex symbols by coding and modulating a transmission bit stream, maps the complex symbols to subcarriers, and configures OFDM symbols through Inverse Fast Fourier Transform (IFFT) operation and Cyclic Prefix (CP) insertion. Also, at data reception, the modem 620 divides a baseband signal provided from the RF processor 610 in an OFDM symbol unit, restores signals mapped to subcarriers through Fast Fourier Transform (FFT) operation, and restores a reception bit stream through demodulation and decoding.

The storage unit 630 stores data of a basic program for an operation of the terminal, an application program and the like. For example, in a case where the terminal is an M2M equipment, the storage unit 630 stores an M2M application. And, the storage unit 630 provides stored data according to a request of the controller 640.

The controller 640 controls a general function of the terminal For example, a signaling processor 644 within the controller 640 generates and provides a control message to the modem 620, and interprets a control message provided from the modem 620. Also, a mode manager 642 within the controller 640 decides an operation mode of the terminal For example, the mode manager 642 determines to convert into a wakeup state while operating in a DCR mode. For instance, in a case where uplink data to be transmitted is generated or a predefined time point of reception of downlink data arrives, the mode manager 642 can determine to convert into the wakeup state. More particularly, the controller 640 controls a function for converting into the wakeup state while operating in the DCR mode, and receiving downlink data discarded in an idle state.

In more detail, in a case where it is determined by the mode manager 642 that there is a need to convert into a wakeup state while the terminal is operating in the DCR mode, the signaling processor 644 performs signaling for transition into the wakeup state. That is, the signaling processor 644 transmits a message of requesting for transition into the wakeup state to a BS through the modem 620 and the RF processor 610, and receives a response message of accepting the transition into the wakeup state. At this time, the controller 640 identifies if information on discarded downlink data transmission is acquired through the signaling. For example, the information on the downlink data transmission can include information representing the existence or non-existence of discarded downlink data, information on downlink data, time information requesting for the maintenance of the wakeup state. Also, the information on the downlink data can include the number of packets included in the discarded downlink data, the kind of packets included in the discarded downlink data, a size per all or packet of the discarded downlink data, a resource amount or time necessary for transmitting the discarded downlink data, information on a sender of the discarded downlink data, timing of generation of the discarded downlink data and the like. As an example, the information on the discarded downlink data transmission can include at least one of IEs of Table 1 above. If the information on the discarded downlink data transmission is acquired through the signaling, the controller 640 controls to receive downlink data using the information on the discarded downlink data transmission. For instance, in a case where the time information requesting for the maintenance of the wakeup state is included, the controller 640 does not return to an idle state during a requested time, and waits reception of the downlink data. For another example, in a case where information about a sender of the downlink data is included, the controller 640 can transmit a request for data retransmission to the sender.

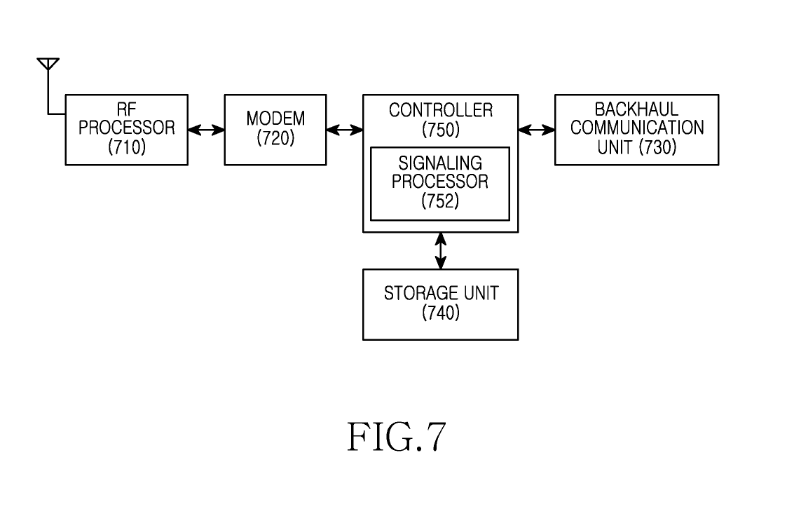

FIG. 7 is a block diagram illustrating a construction of a BS in a broadband wireless access system according to an exemplary embodiment of the present invention.

Referring to FIG. 7, the terminal includes an RF processor 710, a modem 720, a backhaul communication unit 730, a storage unit 740, and a controller 750.

The RF processor 710 performs a function for transmitting/receiving a signal through a wireless channel such as signal band transition, amplification and the like. That is, the RF processor 710 up-converts a baseband signal provided from the modem 720 into an RF band signal and transmits the RF band signal through an antenna, and down-converts an RF band signal received through the antenna into a baseband signal. For example, the RF processor 710 can include an amplifier, a mixer, an oscillator, a DAC, an ADC and the like.

The modem 720 performs a function of transition between a baseband signal and a bit stream according to a physical layer standard of a system. For example, according to an OFDM scheme, at data transmission, the modem 720 generates complex symbols by coding and modulating a transmission bit stream, maps the complex symbols to subcarriers, and configures OFDM symbols through IFFT operation and CP insertion. Also, at data reception, the modem 720 divides a baseband signal provided from the RF processor 710 in an OFDM symbol unit, restores signals mapped to subcarriers through FFT operation, and restores a reception bit stream through demodulation and decoding.

The backhaul communication unit 730 provides an interface for the BS to perform communication with a control station. That is, the backhaul communication unit 730 converts a bit stream transmitted from the BS to the control station into a physical signal, and converts a physical signal received from the control station into a bit stream. The storage unit 740 stores data of a basic program for an operation of the BS, an application program and the like. And, the storage unit 740 provides stored data according to a request of the controller 750.

The controller 750 controls a general function of the BS. For example, a signaling processor 752 within the controller 750 generates and provides a control message to the modem 720 or the backhaul communication unit 730, and interprets a control message provided from the modem 720 or the backhaul communication unit 730. More particularly, the controller 750 controls a function for participating in a signaling procedure for enabling a terminal operating in a DCR mode to convert into a wakeup state.

In a detailed description, if a message of requesting for transition into a wakeup state is received from a terminal operating in a DCR mode, the controller 750 transmits a control station a message of requesting for a state change of the terminal. After that, if a response message to the state change request is received from the control station, the controller 750 extracts information on transmission of discarded downlink data to be transmitted to the terminal, included in the response message. The information on the downlink data transmission can include information representing the existence or non-existence of discarded downlink data and information related to the discarded downlink data. Also, the information on the downlink data transmission can further include time information requesting for the maintenance of the wakeup state. As an example, the information on the discarded downlink data transmission can include at least one of IEs of Table 1 above. And the controller 750 controls to transmit the terminal a response message to the wakeup request, the response message includes the information on the discarded downlink data transmission.

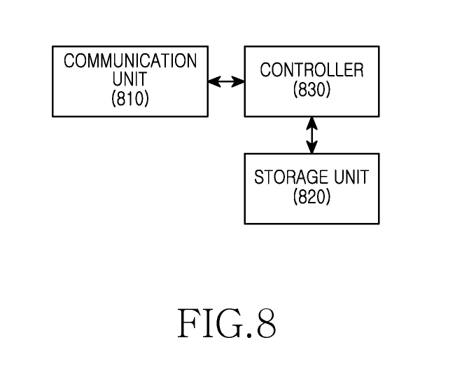

FIG. 8 is a block diagram illustrating a construction of a control station in a broadband wireless access system according to an exemplary embodiment of the present invention.

Referring to FIG. 8, the control station includes a communication unit 810, a storage unit 820, and a controller 830.

The communication unit 810 provides an interface for allowing the control station to perform communication with another intranet node and a core network. That is, the communication unit 810 converts a bit stream transmitted from the control station into a physical signal, and converts a physical signal received by the control station into a bit stream. The storage unit 820 stores data of a basic program for an operation of the control station, an application program, context information of accessed terminals, operation state information of terminals and the like. And, the storage unit 820 provides stored data according to a request of the controller 830.

The controller 830 controls a general function of the control station. That is, the controller 830 routes a packet of a terminal, and manages context information of the terminal. More particularly, the controller 830 controls a function for delivering discarded downlink data to the terminal during a DCR mode.

In more detail, if downlink data for a terminal operating in the DCR mode is generated, for example, if the downlink data for the terminal is received from an intranet server or a core network, the controller 830 determines that it cannot transmit the downlink data as the terminal is operating in the DCR mode. According to this, the controller 830 discards the downlink data, and stores related information of the downlink data. For example, the related information can include the number of packets included in the discarded downlink data, the kind of packets included in the discarded downlink data, a size per all or packet of the discarded downlink data, a resource amount or time necessary for transmitting the discarded downlink data, information on a sender of the discarded downlink data, timing of generation of the discarded downlink data and the like. However, according to another exemplary embodiment of the present invention, the controller 830 can buffer, without discarding, the downlink data in the storage unit 820.

After that, if a message of requesting for transition into a wakeup state of the terminal is received, the controller 830 transmits a response message including information related to discarded downlink data transmission in response to the state change request. The information on the discarded downlink data transmission can include information representing the existence or non-existence of discarded downlink data and information related to the discarded downlink data. Also, the information on the downlink data transmission can further include time information requesting for the maintenance of the wakeup state. As an example, the information on the discarded downlink data transmission can include at least one of IEs of Table 1 above. And, the controller 830 reacquires the discarded downlink data, and transmits the discarded downlink data. For instance, the controller 830 can transmit a request for retransmission to a sender of the downlink data through the communication unit 810. Or, in a case where the downlink data is buffered, the controller 830 can reacquire the downlink data by reading the downlink data stored in the storage unit 820.

Exemplary embodiments of the present invention can prevent a loss of necessary information by delivering, at the time of later wakeup state transition of a terminal, a downlink packet discarded while the terminal operates in a DCR mode in a broadband wireless access system.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An operation method of a terminal in a wireless access system, the method comprising:
determining to transit into a wakeup state while keeping an idle state without confirming the existence or non-existence of downlink data;
performing signaling for the transition into the wakeup state;
acquiring information on discarded downlink data transmission through the signaling; and
receiving the downlink data using the information on the discarded downlink data transmission.

2. The method of claim 1, wherein the information on the discarded downlink data transmission comprises at least one of information representing the existence or non-existence of the discarded downlink data, information related to the discarded downlink data, and time information requesting for the maintenance of the wakeup state.

3. The method of claim 2, wherein the information related to the discarded downlink data comprises at least one of the number of packets comprised in the discarded downlink data, the kind of packets comprised in the discarded downlink data, a size of all of the discarded downlink data, a size of each of packets comprised in the discarded downlink data, a resource amount necessary for transmitting the downlink data, a time necessary for transmitting the downlink data, information on a sender of the downlink data, timing of generation of the downlink data.

4. The method of claim 2, wherein the information on the discarded downlink data transmission comprises at least one Information Element (IE) shown in the following table:

| | IE | Size | Description |
|---|---|---|---|
| LP_IE | Loss Packet Indicator | 1 bit | Indicate if there are |
| (Loss | (LPI) | | packets discarded during |
| Packet IE) | | | DCR mode |
| | Loss Packet Number | 2 bytes | Number of packets |
| | | | discarded during |
| | | | DCR mode |
| | Loss Packet Octet | 4 bytes | Octet count of packets |
| | Count | | discarded during |
| | | | DCR mode |
| SP_IE | SMS Loss Packet | 1 bit | Indicate if there are SMS |
| (SMS Loss | Indicator | | packets discarded during |
| Packet IE) | | | DCR mode |
| | Urgent SMS Loss | 1 bit | Indicate if there are |
| | Packet | | urgent SMS packets |
| | | | discarded during |
| | | | DCR mode |
| | SMS Loss Packet | 2 bytes | Number of SMS packets |
| | Number | | discarded during |
| | | | DCR mode |
| | SMS Loss Packet | 4 bytes | Octet count of |
| | Octet Count | | SMS packets discarded |
| | | | during DCR mode |
| DIR_IE | Wakeup Time | In | Terminal does not return |
| | | seconds | to DCR mode or idle |
| | | | mode during wakeup |
| | | | time |
| Additional | List of source IP | | |
| Information | addresses of the | | |
| | discarded message | | |
| | List of source | | |
| | addresses of the | | |
| | discarded SMS | | |
| | message or the | | |
| | discarded urgent SMS | | |
| | messages | | |

5. The method of claim 1, wherein the determining to transit into the wakeup state comprises determining to convert into the wakeup state in a case where uplink data to be transmitted is generated or a predefined time point of reception of downlink data arrives.

6. The method of claim 1, wherein the terminal comprises a Machine to Machine (M2M) equipment.

7. An operation method of a control station in a wireless access system, the method comprising:
discarding or buffering downlink data when the downlink data for a terminal being in an operation mode of keeping an idle state without confirming the existence or non-existence of downlink data is generated;
storing information about the downlink data;
if there is a request for a state change into a wakeup state of the terminal, transmitting information on discarded downlink data transmission through a signaling procedure for the state change;
reacquiring discarded downlink data; and
transmitting the discarded downlink data.

8. The method of claim 7, wherein the information on the downlink data comprises at least one of the number of packets comprised in the discarded downlink data, the kind of packets comprised in the discarded downlink data, a size of all of the discarded downlink data, a size of each of packets comprised in the downlink data, a resource amount necessary for transmitting the downlink data, a time necessary for transmitting the downlink data, information on a sender of the downlink data, and timing of generation of the downlink data.

9. The method of claim 7, wherein the information on the discarded downlink data transmission comprises at least one of information representing the existence or non-existence of the discarded downlink data, information related to the discarded downlink data, and time information requesting for the maintenance of the wakeup state.

10. The method of claim 7, wherein the information on the discarded downlink data transmission comprises at least one Information Element (IE) shown in the following table:

| | IE | Size | Description |
|---|---|---|---|
| LP_IE | Loss Packet Indicator | 1 bit | Indicate if there are |
| (Loss | (LPI) | | packets discarded during |
| Packet IE) | | | DCR mode |
| | Loss Packet Number | 2 bytes | Number of packets |
| | | | discarded during |
| | | | DCR mode |
| | Loss Packet Octet | 4 bytes | Octet count of packets |
| | Count | | discarded during |
| | | | DCR mode |
| SP_IE | SMS Loss Packet | 1 bit | Indicate if there are |
| (SMS Loss | Indicator | | SMS packets discarded |
| Packet IE) | | | during DCR mode |
| | Urgent SMS Loss | 1 bit | Indicate if there are |
| | Packet | | urgent SMS packets |
| | | | discarded during DCR |
| | | | mode |
| | SMS Loss Packet | 2 bytes | Number of SMS packets |
| | Number | | discarded during |
| | | | DCR mode |
| | SMS Loss Packet | 4 bytes | Octet count of SMS |
| | Octet Count | | packets discarded |
| | | | during DCR mode |
| DIR_IE | Wakeup Time | In | Terminal does not |
| | | seconds | return to DCR mode or |
| | | | idle mode during |
| | | | wakeup time |
| Additional | List of source IP | | |
| Information | addresses of the | | |
| | discarded message | | |
| | List of source | | |
| | addresses of the | | |
| | discarded SMS | | |
| | message or the | | |
| | discarded urgent SMS | | |
| | messages | | |

11. The method of claim 7, wherein the reacquiring of the discarded downlink data comprises transmitting a request for retransmission to a sender of the downlink data.

12. The method of claim 7, wherein the reacquiring of the discarded downlink data comprises reading out the buffered downlink data.

13. The method of claim 7, wherein the terminal comprises a Machine to Machine (M2M) equipment.

14. An operation method of a Base Station (BS) in a wireless access system, the method comprising:
if a first message of requesting for transition into a wakeup state is received from a terminal being in an operation mode of keeping an idle state without confirming the existence or non-existence of downlink data, transmitting a control station a second message of requesting for a state change of the terminal; and
if a response message comprising information on transmission of discarded downlink data to be transmitted to the terminal is received in response to the second message, transmitting the terminal a response message comprising the information on a discarded downlink data transmission in response to the first message.

15. The method of claim 14, wherein the information on the discarded downlink data transmission comprises at least one of information representing the existence or non-existence of the discarded downlink data, information related to the discarded downlink data, and time information requesting for the maintenance of the wakeup state.

16. The method of claim 15, wherein the information related to the discarded downlink data comprises at least one of the number of packets comprised in the discarded downlink data, the kind of packets comprised in the discarded downlink data, a size of all of the discarded downlink data, a size of each of packets comprised in the discarded downlink data, a resource amount necessary for transmitting the downlink data, a time necessary for transmitting the downlink data, information on a sender of the downlink data, and timing of generation of the downlink data.

17. The method of claim 16, wherein the information on the discarded downlink data transmission comprises at least one Information Element (IE) shown in the following table:

| | IE | Size | Description |
|---|---|---|---|
| LP_IE | Loss Packet Indicator | 1 bit | Indicate if there are |
| (Loss | (LPI) | | packets discarded during |
| Packet IE) | | | DCR mode |
| | Loss Packet Number | 2 bytes | Number of packets |
| | | | discarded during |
| | | | DCR mode |
| | Loss Packet Octet | 4 bytes | Octet count of packets |
| | Count | | discarded during |
| | | | DCR mode |
| SP_IE | SMS Loss Packet | 1 bit | Indicate if there are |
| (SMS Loss | Indicator | | SMS packets discarded |
| Packet IE) | | | during DCR mode |
| | Urgent SMS Loss | 1 bit | Indicate if there are |
| | Packet | | urgent SMS packets |
| | | | discarded during |
| | | | DCR mode |
| | SMS Loss Packet | 2 bytes | Number of SMS packets |
| | Number | | discarded during DCR |
| | | | mode |
| | SMS Loss Packet | 4 bytes | Octet count of SMS |
| | Octet Count | | packets discarded |
| | | | during DCR mode |
| DIR_IE | Wakeup Time | In | Terminal does not return |
| | | seconds | to DCR mode or idle |
| | | | mode during wakeup |
| | | | time |
| Additional | List of source IP | | |
| Information | addresses of the | | |
| | discarded message | | |
| | List of source | | |
| | addresses of the | | |
| | discarded SMS | | |
| | message or the | | |
| | discarded urgent SMS | | |
| | messages. | | |

18. A terminal apparatus in a wireless access system, the apparatus comprising:
a controller for, while keeping an idle state without confirming the existence or non-existence of downlink data, determining to transit into a wakeup state, performing signaling for the transition into the wakeup state, and acquiring information on discarded downlink data transmission through the signaling; and
a modulator/demodulator (modem) for receiving the downlink data using the information on the discarded downlink data transmission.

19. The apparatus of claim 18, wherein the information on the discarded downlink data transmission comprises at least one of information representing the existence or non-existence of the discarded downlink data, information related to the discarded downlink data, and time information requesting for the maintenance of the wakeup state.

20. The apparatus of claim 19, wherein the information related to the discarded downlink data comprises at least one of the number of packets comprised in the discarded downlink data, the kind of packets comprised in the discarded downlink data, a size of all of the discarded downlink data, a size of each of packets comprised in the downlink data, a resource amount necessary for transmitting the downlink data, a time necessary for transmitting the downlink data, information on a sender of the downlink data, and timing of generation of the downlink data.

21. The apparatus of claim 19, wherein the information on the discarded downlink data transmission comprises at least one Information Element (IE) shown in the following table:

| | IE | Size | Description |
|---|---|---|---|
| LP_IE | Loss Packet Indicator | 1 bit | Indicate if there are |
| (Loss | (LPI) | | packets discarded during |
| Packet IE) | | | DCR mode |
| | Loss Packet Number | 2 bytes | Number of packets |
| | | | discarded during |
| | | | DCR mode |
| | Loss Packet Octet | 4 bytes | Octet count of packets |
| | Count | | discarded during |
| | | | DCR mode |
| SP_IE | SMS Loss Packet | 1 bit | Indicate if there are |
| (SMS Loss | Indicator | | SMS packets discarded |
| Packet IE) | | | during DCR mode |
| | Urgent SMS Loss | 1 bit | Indicate if there are |
| | Packet | | urgent SMS packets |
| | | | discarded during |
| | | | DCR mode |
| | SMS Loss Packet | 2 bytes | Number of SMS |
| | Number | | packets discarded |
| | | | during DCR mode |
| | SMS Loss Packet | 4 bytes | Octet count of SMS |
| | Octet Count | | packets discarded |
| | | | during DCR mode |
| DIR_IE | Wakeup Time | In | Terminal does not return |
| | | seconds | to DCR mode or idle |
| | | | mode during wakeup |
| | | | time |
| Additional | List of source IP | | |
| Information | addresses of the | | |
| | discarded message | | |
| | List of source | | |
| | addresses of the | | |
| | discarded SMS | | |
| | message or the | | |
| | discarded urgent SMS | | |
| | messages. | | |

22. The apparatus of claim 18, wherein the controller determines to convert into the wakeup state in a case where uplink data to be transmitted is generated or a predefined time point of reception of downlink data arrives.

23. The apparatus of claim 18, wherein the terminal comprises a Machine to Machine (M2M) equipment.

24. A control station apparatus in a wireless access system, the apparatus comprising:
a controller for, if downlink data for a terminal being in an operation mode of keeping an idle state without confirming the existence or non-existence of downlink data is generated, discarding or buffering the downlink data, and storing information about the downlink data; and
a communication unit for, if there is a request for a state change into a wakeup state of the terminal, transmitting information on discarded downlink data transmission through a signaling procedure for the state change,
wherein the controller controls to reacquire the discarded downlink data, and transmit the discarded downlink data.

25. The apparatus of claim 24, wherein the information on the downlink data comprises at least one of the number of packets comprised in the discarded downlink data, the kind of packets comprised in the discarded downlink data, a size of all of the discarded downlink data, a size of each of packets comprised in the downlink data, a resource amount necessary for transmitting the downlink data, a time necessary for transmitting the downlink data, information on a sender of the downlink data, and timing of generation of the downlink data.

26. The apparatus of claim 24, wherein the information on the discarded downlink data transmission comprises at least one of information representing the existence or non-existence of the discarded downlink data, information related to the discarded downlink data, and time information requesting for the maintenance of the wakeup state.

27. The apparatus of claim 24, wherein the information on the discarded downlink data transmission comprises at least one Information Element (IE) shown in the following table:

| | IE | Size | Description |
|---|---|---|---|
| LP_IE | Loss Packet Indicator | 1 bit | Indicate if there are |
| (Loss | (LPI) | | packets discarded during |
| Packet IE) | | | DCR mode |
| | Loss Packet Number | 2 bytes | Number of packets |
| | | | discarded during |
| | | | DCR mode |
| | Loss Packet Octet | 4 bytes | Octet count of packets |
| | Count | | discarded during |
| | | | DCR mode |
| SP_IE | SMS Loss Packet | 1 bit | Indicate if there are |
| (SMS Loss | Indicator | | SMS packets discarded |
| Packet IE) | | | during DCR mode |
| | Urgent SMS Loss | 1 bit | Indicate if there are |
| | Packet | | urgent SMS packets |
| | | | discarded during |
| | | | DCR mode |
| | SMS Loss Packet | 2 bytes | Number of SMS packets |
| | Number | | discarded during |
| | | | DCR mode |
| | SMS Loss Packet | 4 bytes | Octet count of SMS |
| | Octet Count | | packets discarded during |
| | | | DCR mode |
| DIR_IE | Wakeup Time | In | Terminal does not return |
| | | seconds | to DCR mode or idle |
| | | | mode during wakeup |
| | | | time |
| Additional | List of source IP | | |
| Information | addresses of the | | |
| | discarded message | | |
| | List of source | | |
| | addresses of the | | |
| | discarded SMS | | |
| | message or the | | |
| | discarded urgent SMS | | |
| | messages | | |

28. The apparatus of claim 24, wherein the controller reacquires the discarded downlink data by transmitting a request for retransmission to a sender of the downlink data.

29. The apparatus of claim 24, wherein the controller reacquires the discarded downlink data by reading out the buffered downlink data.

30. The apparatus of claim 24, wherein the terminal comprises a Machine to Machine (M2M) equipment.

31. A Base Station (BS) apparatus in a wireless access system, the apparatus comprising:
a modulator/demodulator (modem) for, if a first message of requesting for transition into a wakeup state is received from a terminal being in an operation mode of keeping an idle state without confirming the existence or non-existence of downlink data, transmitting a control station a second message of requesting for a state change of the terminal; and
a controller for, if a response message comprising information on transmission of discarded downlink data to be transmitted to the terminal is received in response to the second message, controlling to transmit the terminal a response message comprising the information on the discarded downlink data transmission in response to the first message.

32. The apparatus of claim 31, wherein the information on the discarded downlink data transmission comprises at least one of information representing the existence or non-existence of the discarded downlink data, information related to the discarded downlink data, and time information requesting for the maintenance of the wakeup state.

33. The apparatus of claim 32, wherein the information related to the discarded downlink data comprises at least one of the number of packets comprised in the discarded downlink data, the kind of packets comprised in the discarded downlink data, a size of all of the discarded downlink data, a size of each of packets comprised in the discarded downlink data, a resource amount necessary for transmitting the downlink data, a time necessary for transmitting the downlink data, information on a sender of the downlink data, and timing of generation of the downlink data.

34. The apparatus of claim 32, wherein the information on the discarded downlink data transmission comprises at least one Information Element (IE) shown in the following table:

| | IE | Size | Description |
|---|---|---|---|
| LP_IE | Loss Packet Indicator | 1 bit | Indicate if there are |
| (Loss | (LPI) | | packets discarded during |
| Packet IE) | | | DCR mode |
| | Loss Packet Number | 2 bytes | Number of packets |
| | | | discarded during |
| | | | DCR mode |
| | Loss Packet Octet | 4 bytes | Octet count of packets |
| | Count | | discarded during |
| | | | DCR mode |
| SP_IE | SMS Loss Packet | 1 bit | Indicate if there are |
| (SMS Loss | Indicator | | SMS packets discarded |
| Packet IE) | | | during DCR mode |
| | Urgent SMS Loss | 1 bit | Indicate if there are |
| | Packet | | urgent SMS packets |
| | | | discarded during |
| | | | DCR mode |
| | SMS Loss Packet | 2 bytes | Number of SMS packets |
| | Number | | discarded during |
| | | | DCR mode |
| | SMS Loss Packet | 4 bytes | Octet count of SMS |
| | Octet Count | | packets discarded during |
| | | | DCR mode |
| DIR_IE | Wakeup Time | In | Terminal does not return |
| | | seconds | to DCR mode or idle |
| | | | mode during wakeup |
| | | | time |
| Additional | List of source IP | | |
| Information | addresses of the | | |
| | discarded message | | |
| | List of source | | |
| | addresses of the | | |
| | discarded SMS | | |
| | message or the | | |
| | discarded urgent SMS | | |
| | messages. | | |
